(19) United States
(12) Patent Application Publication
(10) Pub. No.: US 2020/0158046 A1
(43) Pub. Date: May 21, 2020

(54) METHOD FOR PRODUCING A PISTON FOR AN INTERNAL COMBUSTION ENGINE, PISTON FOR AN INTERNAL COMBUSTION ENGINE, PISTON BLANK FOR PRODUCING THE PISTON, AND CASTING MOLD OR FORGING DIE FOR PRODUCING A PISTON BLANK

(71) Applicant: FEDERAL-MOGUL NURNBERG GMBH, NURNBERG (DE)

(72) Inventors: ULRICH HENZOLD, NURNBERG (DE); HARALD MERGLER, NURNBERG (DE); CHRISTOFFER SCHMOLL, NURNBERG (DE)

(21) Appl. No.: 16/628,433

(22) PCT Filed: Jul. 2, 2018
(86) PCT No.: PCT/EP2018/067789

§ 371 Date: Jan. 3, 2020

(30) Foreign Application Priority Data
Jul. 4, 2017 (DE) 11 2017 211 335.9

(51) Int. Cl. F02F 3/22; F02F 3/02; F02F 3/18

(52) U.S. Cl. CPC F02F 3/22; F02F 3/0084; F02F 3/18; F02F 3/02

(57) ABSTRACT

A method for producing a piston blank or a piston for an internal combustion engine, includes providing a thickened portion formed in at least one box wall in the direction of thickness approximately in the center thereof, which is at least partly flush with a cooling channel. A resulting piston blank or piston having these features can be made in a casting mold or forging die designed in a corresponding manner.

### TECHNICAL FIELD

The invention relates to a method for producing a piston for an internal combustion engine, a piston for an internal combustion engine, a piston blank for producing the piston, and a casting mold or forging die for producing a piston blank.

In the field of pistons for internal combustion engines, it is customary for the purposes of cooling the piston to form a largely ring-shaped cooling channel which is supplied with cooling oil by means of at least one inlet proceeding largely parallel to the piston axis, said cooling oil leaving the cooling channel at at least one outlet which likewise proceeds substantially parallel to the piston axis.

### PRIOR ART

JP 58190538 A relates to a forged piston in which the coolant inlets and outlets are formed directly in the area of the piston pin bosses. The same applies for the piston according to CN 205297761 U.

Finally, DE 10 2014 222 416 A1 reveals an aluminium piston in which the coolant inlets and outlets are formed on the outside on the so-called box walls, which extend between the (load-bearing) shaft walls and receive the piston bin bosses.

### SUMMARY OF THE INVENTION

Against this background, the object of the invention is firstly to create a method for producing a piston with the aid of which a piston which is improved with respect to the so-called retention rate, in other words the proportion of the cooling oil actually reaching the cooling channel, can be produced in an efficient manner. Furthermore, a corresponding piston, piston blank and casting mold or forging die are to be created for it.

This object is accomplished using the method described in claim 1.

Accordingly, already as part of the production of a piston blank, a thickened portion is formed in at least one box wall in the direction of thickness approximately in the center thereof, which is at least partly flush with a cooling channel. The thickened portion described can be used to form the coolant inlets and outlets in that an opening leading to the cooling channel, in particular a bore, is created. Thus, only a few production steps are required, and no additional components, so that simple and cost-efficient production is enabled. At the same time, it can be ensured that a sufficient quantity of cooling oil reaches the cooling channel during operation.

Furthermore, since the thickened portion is formed in a box wall and not directly adjacent to a piston pin boss, an undesirable mass of material is thereby avoided. Moreover, a sufficiently great distance from moving parts such as a connecting rod can be kept in an advantageous manner.

Measures preferred for this purpose and preferred further developments are described in the further claims.

At least in certain applications there are advantages if at least one box wall is formed on the outside on a piston pin boss since sufficient space for the bores is thereby created in an advantageous manner, and at the same time the necessary distance from the connecting rod as a moving part is kept.

Although as part of the method according to the invention the production of a light metal, in particular aluminium, piston and/or through casting is also possible, the current preference is, according to the invention, to make the piston blank by forging and/or from iron or steel. Steel or iron casting, in particular ductile iron, is preferred as the casting method.

The retention rate can be further increased in an advantageous manner by reworking at least one thickened portion mechanically such that at least one coolant inlet or outlet bore is formed at least partially in a funnel shape.

In certain applications it has further proved to be advantageous if two thickened portions are formed in each of both box walls, so that a total of four inlet or outlet bores are present.

It also offers advantages in certain situations if the cooling channel is filled with a coolant such as sodium, and is subsequently sealed.

In accordance with the method described above, the piston according to the invention is provided with at least one thickened portion which advantageously is not mechanically reworked, with the exception of a bore possibly formed therein. The piston blank according to the invention that is used for this purpose and the casting mold or forging die according to the invention correspond to the fore-mentioned features of the method according to the invention. This equally applies to the preferred embodiments, and it should be mentioned that all features mentioned in connection with the method, the piston, the piston blank, the casting mold and/or the forging die can equally be applied to the respective other subject matters of this application and vice versa.

### BRIEF DESCRIPTION OF THE DRAWINGS

A preferred embodiment example of the invention is described in more detail below with reference to the figures.

FIG. 1 shows a bottom view of a piston blank according to the invention, and

FIG. 2 shows a sectional view through a piston according to the invention.

### COMPREHENSIVE DESCRIPTION OF A PREFERRED EMBODIMENT OF THE INVENTION

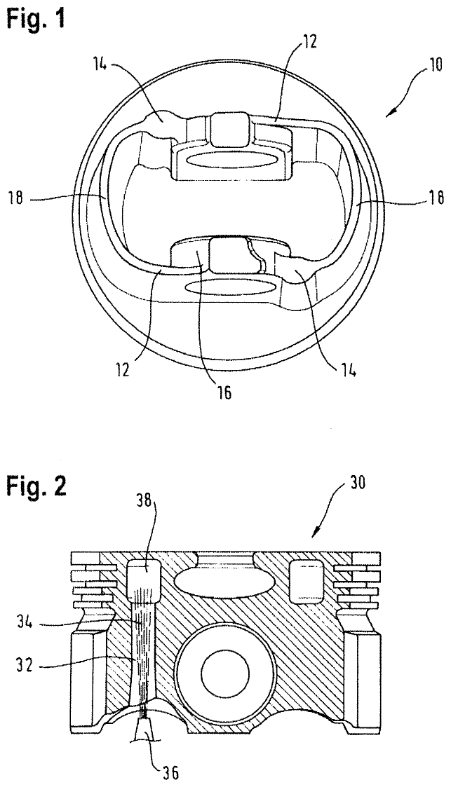

As FIG. 1 shows, a piston blank 10 according to the invention has two load-bearing shaft wall portions 18 and two box walls 12 which receive the piston pin bosses 16. As can further be seen in the figure, a thickened portion 14 is formed at two diametrically opposed points in the box wall, which lies approximately in the center of the box wall to the extent that the box wall would, in an imagined continued path, proceed approximately centrally through the thickened portion 14. In other words, the box wall is “bulged” in both directions, to the inside and to the outside, in order to form the thickened portion described. In other words, the respective thickened portion is preferably formed substantially symmetrically with respect to the box wall 12 as an axis of symmetry.

As can be seen in FIG. 2, a bore 32 can be created in a direction approximately parallel to the piston axis (in FIG. 1 perpendicular to the reference plane, in FIG. 2 from top to bottom), said bore, as shown in FIG. 2, enabling the supply of cooling oil 34 from a cooling nozzle 36 into a cooling channel 38. In order to increase the retention rate in this connection, the bore 32 is widened in a funnel shape at its end opposite the cooling channel 38.

FIG. 1 also reveals that in the case shown the box walls 12 are formed on the outside on the piston pin bosses 16. However, the piston pin bosses 16 can protrude or spring back relative to the box walls 12.

1-9. (canceled)

10. A method for producing a piston for an internal combustion engine, in which, as part of the production of a piston blank by forging, a thickened portion is formed by forging in at least one box wall in the direction of thickness in the center thereof, which is at least partly flush with a cooling channel; at least one box wall is formed on the outside on a piston pin boss.

11. The method according to claim 10, wherein the piston blank is made from iron or steel.

12. The method according to claim 10, wherein the at least one thickened portion is mechanically reworked such that at least one coolant inlet or outlet bore is formed at east partially in a funnel shape.

13. The method according to claim 10, wherein there are two thickened portions formed in each of both box walls.

14. The method according to claim 10, wherein the cooling channel is filled with a coolant and subsequently sealed.

15. A piston for an internal combustion engine having at least one box wall in which a thickened portion is formed by forging in the direction of thickness in the center, which is not mechanically reworked with the exception of a bore formed therein, with at least one box wall being formed on the outside on a piston boss.

16. The piston according to claim 15, wherein a bore is formed in at least one thickened portion, which is formed at least partially in a funnel shape.

17. A piston for an internal combustion engine, comprising:
a piston body having a pair of pin bosses each received in a box wall extending laterally of the pin bosses to opposite sides thereof;
an annular cooling channel disposed above the pin bosses;
at least one of said box walls having a locally thickened region extending in a longitudinal direction of the piston; and
wherein said locally thickened section is provided laterally outward of the pin bosses and includes a bore open at a bottom of the at least one thickened portion and communicating at an open end of the bore with said cooling channel.

18. The piston of claim 17, wherein a lower end of the bore is flared.

19. The piston of claim 17, wherein the bore enables the supply of cooling oil from a cooling nozzle into the cooling channel.
